(19) United States
(12) Patent Application Publication
(10) Pub. No.: US 2019/0257330 A1
(43) Pub. Date: Aug. 22, 2019

(54) VORTEX FLOW CATALYTIC CONVERSION APPARATUS AND METHOD OF VORTEX FLOW CATALYTIC CONVERSION

(71) Applicant: VTX Technology LLC, Southfield, MI (US)

(72) Inventors: David H. Hill, Birmingham, MI (US); Lynn L. Faulkner, Westerville, OH (US); Chester Ellsworth Dietrick, III, Grosse Ile, MI (US)

(21) Appl. No.: 15/899,107

(22) Filed: Feb. 19, 2018

(51) Int. Cl. F15D 1/00; B01D 53/94; F01N 1/08

(52) U.S. Cl. CPC F15D 1/0015; B01D 53/9459; F01N 1/087; B01D 2201/62; B01D 2255/102; F01N 2510/06; B01D 2257/502; B01D 2257/702; B01D 2258/01; F01N 2370/02; F01N 2470/18; B01D 2255/905

(57) ABSTRACT

A vortex flow catalytic conversion apparatus and a method of vortex flow catalytic conversion of a fluid is provided. The apparatus includes a housing having an interior surface defining a cylindrical chamber. A helical separator is disposed within the chamber and cooperates with the interior side wall of the chamber to define a helical passageway for inducing a vortex flow. A deflector is disposed downstream of the helical separator to redirect the vortex flow exiting the helical passageway to an axial flow. A catalytic converter is disposed in the chamber downstream of the deflector. A catalyst coating is applied to at least one of the interior surface, helical separator, and catalytic converter. The method includes exposing a vortex flow of fluid to a first catalyst coating. The vortex flow is then redirected to an axial flow and exposed to a second catalyst coating.

### FIELD

The invention relates generally to a fluid flow apparatus; more particularly to an apparatus that physically and chemically act upon a fluid flowing through the apparatus.

### BACKGROUND

The statements in this section merely provide background information related to the present disclosure and may or may not constitute prior art. Internal combustion engines and external combustion engines, and particularly those used in motor vehicles and fossil fuel power generation plants, are known major sources of atmospheric pollution. Government legislation has spurred development of suitable fluid conversion apparatuses for reducing undesirable constituents contained in the exhaust gases from internal and external combustion engines.

The solution generally adopted by motor vehicle manufacturers is to pass the exhaust gases from an internal combustion engine of the motor vehicle through a fluid conversion apparatus that is a catalytic converter, to reduce or eliminate by oxidation and reduction of various undesirable constituents in the exhaust gases. A catalytic converter is generally positioned in the exhaust system of the motor vehicle as a separate unit between the engine exhaust manifold and the muffler. The hot exhaust gases emitted from the internal combustion engine are passed through a catalyst bed contained in the catalytic converter. The catalyst are typically deposited upon small ceramic spheres, pellets, or a suitable ceramic structure of cylindrical or hexagonal tubes arrayed in parallel honeycomb fashion through which exhaust gases flow.

Automotive catalyst material is made either of a ceramic or metallic substrate on which is deposited a catalyst. The catalyst typically include precious metals such as platinum, palladium, rhodium, and to a lesser extent, cerium, iron, and manganese. Typically, platinum is used both as a reduction and oxidation catalyst, palladium is used as an oxidation catalyst, and rhodium is used as a reduction catalyst. Typically, the precious metals are coated onto a honeycombed ceramic monolith structure. The honeycombed structure increase the surface area available for the exhaust gases to contact the catalyst while minimizing the restriction of the flow of exhaust gas through the exhaust system.

Platinum, palladium, and rhodium are part of a group of noble metals known as the platinum group. All three of these platinum group metals, or PGMs, are extremely rare but have a broad range of applications in addition to catalytic converters, resulting in a high demand and high cost for these metals. Thus, while current catalytic converters achieve their intended purpose, there is a need for a new and improved fluid flow apparatus that physically and chemically act on a fluid flow, such as the exhaust gases from an internal or external combustion engine, that is more efficient, thereby reducing the precious metal content while simple to manufacture.

### SUMMARY

According to several aspects, a vortex flow catalytic conversion apparatus is disclosed. The vortex flow catalytic conversion apparatus includes an elongated housing having a first end, a second end opposite of the first end, and an interior surface defining a chamber having an interior side wall; an inlet tube extending from the housing proximal to the first end, wherein the inlet tube defines an inlet opening into the chamber; an outlet tube extend from the housing proximal to the second end, wherein the outlet tube defines an outlet opening; a helical separator disposed within the chamber, wherein the helical separator cooperates with the interior side wall to define a helical passageway for inducing a vortex flow of fluid; and a catalyst coating applied on a portion of at least one of the interior side wall and the helical separator.

In an additional aspect of the present disclosure, the vortex flow catalytic conversion apparatus further includes a catalytic converter disposed in the chamber downstream of the deflector. The catalytic converter includes a plurality of tubes defining a plurality of axial fluid flow passageways.

In another aspect of the present disclosure, the vortex flow catalytic conversion apparatus further includes a deflector disposed in the chamber downstream of the helical separator and upstream of the catalytic converter. The deflector includes vanes configured to redirect the vortex flow of fluid exiting the helical passageway to an axial flow of fluid.

In another aspect of the present disclosure, the catalytic converter is a clean-up catalytic converter.

In another aspect of the present disclosure, the catalyst coating includes one of an oxidation phase coating or reduction phase coating applied on an upstream portion of the interior side wall, and the other of the oxidation phase coating or reduction phase coating applied on a downstream portion of the interior side wall. Alternatively, a combination oxidation and reduction phase coating is applied to the upstream and/or downstream portions of the interior side wall or helical separator.

In another aspect of the present disclosure, the helical separator includes an elongated member having a vane extending helically from a first distal end toward a second distal end of the elongated member. The vane includes a first surface and a second surface opposite the first surface. One of the first and second surfaces is coated with one of a reduction coating or oxidation coating, and the other of the first and second surfaces is coated with the other of the reduction coating or oxidation coating.

In another aspect of the present disclosure, the vane includes an edge surface connecting the first surface and the second surface. The lengths between adjacent helical vane edge surfaces and angles α of helical vane surfaces are varied.

In another aspect of the present disclosure, the helical separator includes a plurality of ribs protruding from at least one of the elongated member, the first surface of the vane, and the second surface of the vane.

In another aspect of the present disclosure, the vortex flow catalytic conversion apparatus further includes a first set of ribs protruding into the helical passageway in a first helical direction from the interior side wall and a second set of ribs protruding into the helical passageway in a second helical direction from the interior side wall.

In another aspect of the present disclosure, the inlet tube extends from the housing at an angle from 90 degrees to an angle of the helical vane adjacent the inlet tube, relative to a longitudinal axis of the housing.

In another aspect of the present disclosure, the vortex flow catalytic conversion apparatus further includes an exterior wall shielding at least a portion of the elongated housing. A heating jacket disposed between the elongated housing and exterior wall.

According to several aspects, a vortex flow apparatus is disclosed. The vortex flow apparatus includes an elongated housing extending along an axis. The elongated housing includes a first end, a second end opposite the first end, and an interior surface defining a cylindrical chamber having an interior side wall; an inlet tube extending tangentially from the elongated housing proximal to the first end; an outlet tube extending from the elongated housing proximal to the second end; a helical separator disposed within the cylindrical chamber, wherein the helical separator cooperates with the interior side wall to define a helical fluid flow passageway extending from the first end toward the second end; and a deflector disposed within the cylindrical chamber downstream of the helical separator, wherein the deflector is configured to redirect a helical fluid flow exiting the helical fluid flow passageway into an axial fluid flow toward the outlet tube.

In an additional aspect of the present disclosure, the vortex flow apparatus further includes a catalytic converter disposed downstream of the deflector. The catalytic converter includes a plurality of tubes defining a plurality of axially flow passageways for receiving the axial fluid flow from the deflector.

In another aspect of the present disclosure, the catalytic converter defines a central opening. The helical separator includes an elongated member having a first distal end and a second distal end opposite the first distal end. The first distal end is fixed to the interior surface proximal to the first end of the housing and the second distal end is received within the central opening of the catalytic converter.

In another aspect of the present disclosure, the helical separator includes a vane extending from an external surface in a helical path from the first end to the second distal end. The vane includes a first surface, a second surface opposite the first surface, and an edge surface connecting the first surface with the second surface. The edge surface includes a profile that is complementary to the shape of the interior surface of the cylindrical chamber such that the edge surface conformingly abuts the interior surface.

In another aspect of the present disclosure, the vortex flow apparatus further includes a catalyst coating applied at least one of the interior surface of the housing, first surface of the vane, second surface of the vane, and the catalytic converter.

According to several aspects, a method of vortex flow catalytic conversion of a fluid is disclosed. The method includes the steps of creating a vortex flow of a fluid by passing the fluid through a helical passageway about a longitudinal axis and exposing the vortex flow of fluid to at least one catalyst coating in the helical passageway.

In another aspect of the present disclosure, the method further includes the steps of redirecting the vortex flow of the fluid exiting the helical passageway to an axial flow of the fluid along the longitudinal axis, and passing the axial flow of fluid through a catalytic coated substrate.

According to several aspects, the method further includes the step of exposing the vortex flow of the fluid to a plurality of ribs protruding into the helical passageway, thereby enhancing turbulence in the vortex flow of fluid.

According to several aspects, the method further includes the step of heating the vortex flow of fluid in the helical passageway to a temperature conducive to effective conversion of the fluid flow by the catalyst coating.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a vortex flow apparatus, according to an exemplary embodiment;

FIG. 2 is a diagrammatic side cross-section view of the vortex flow apparatus of FIG. 1;

FIG. 3A is a diagrammatic cross-section view of the vortex flow apparatus along line 3-3 of FIG. 2 showing an inlet tube;

FIG. 3B is a diagrammatic cross-section view of an alternative embodiment 3A;

FIG. 4 is a diagrammatic cross-section view of the vortex flow apparatus along line 4-4 of FIG. 2 showing a deflector;

FIG. 5 is a diagrammatic cross-section view of the vortex flow apparatus along line 5-5 of FIG. 2 showing a catalytic converter;

FIG. 6A is a fragmentary diagrammatic cross-section view of the vortex flow apparatus along line 6-6 of FIG. 2 showing a segment of the housing; and

FIG. 6B is a fragmentary diagrammatic cross-section view of an alternative embodiment of FIG. 6A.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not to be interpreted as limiting, but as a representative basis for teaching one skilled in the art as to how to practice the disclosed concepts.

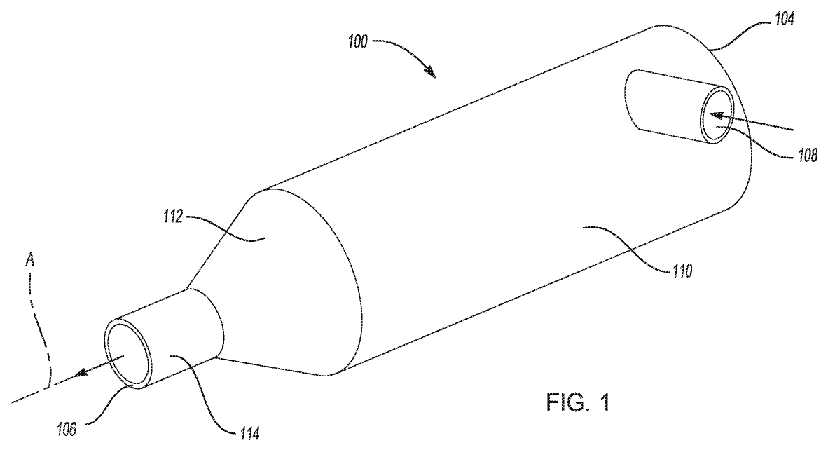

FIG. 1 shows a perspective view of an exemplary embodiment of a vortex flow apparatus 100 configured to physically and chemically act upon a fluid flow there-through. The vortex flow apparatus 100 includes an elongated housing 102 extending along an A-axis. The elongated housing 102 includes a first end 104 and a second end 106 opposite the first end 104 along the A-axis. An inlet tube 108 extends tangentially from a side wall 110 of the housing 102 proximal to the first end 104. The housing 102 includes a tapered portion 112 that narrows along the A-axis toward the second end 106 defining an outlet tube 114. In the embodiment shown in FIG. 1, the elongated housing 102 is cylindrical in shape and the tapered portion 112 is conical in shape, while both the inlet tube 108 and outlet tube 114 are tubular in shape, but should not to be interpreted to be so limited. It is to be understood that the disclosed embodiment of the vortex flow apparatus 100 is intended to be merely an example that may be embodied in various and alternative forms.

The inlet tube 108 is configured to fluidly connect to an inlet header (not shown) for receiving a fluid flow. As an example, the fluid flow may be that of exhaust gases generated from the combustion of fossil fuel such as that from an internal combustion engine or external combustion engine. In this particular example, the exhaust gases enters the inlet tube 108, flows through the vortex flow apparatus 100, and exits the outlet tube 114. The housing 102 contains features that chemically transforms the undesirable constituents contained in the exhaust gases to substantially environmentally inert constituents. An example is the chemical transformation of carbon-monoxide (CO) to carbon-dioxide (CO₂). The outlet tube 114 is configured to fluidly connect to an outlet header (not shown) for the discharge or dissipation of the chemically transformed exhaust gases.

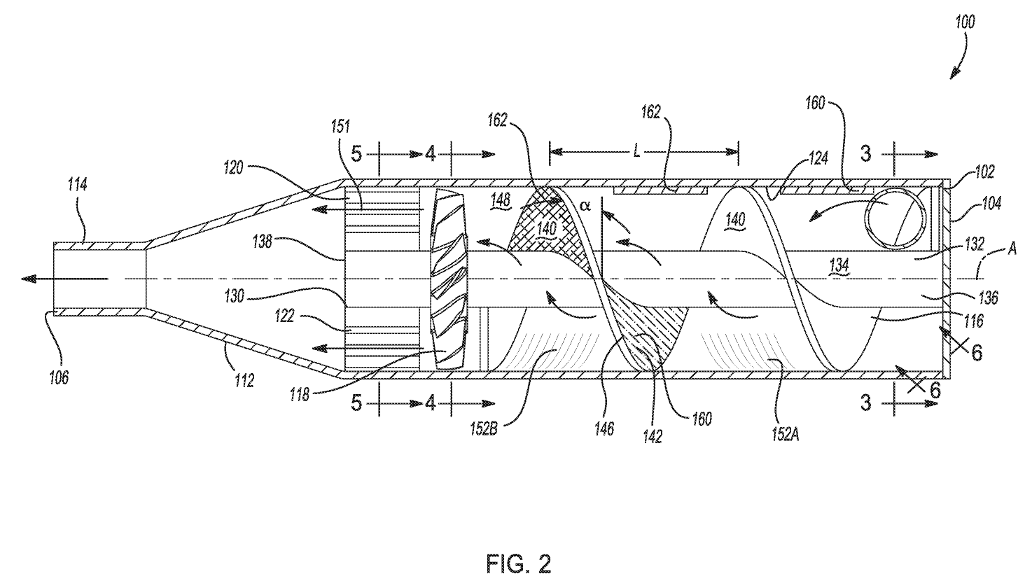

FIG. 2 shows a diagrammatic side cross-section view of the vortex flow apparatus 100 of FIG. 1. The housing 102 of the vortex flow apparatus 100 contains a helical separator 116 disposed between the first end 104 and the tapered portion 112. The helical separator 116 induces a vortex flow, also referred to as helical flow, of fluid through the vortex flow apparatus 100. The angle of the helix may be varied to suit the application. A deflector 118 is disposed within the housing 102 downstream of the helical separator 116. The deflector 118 is configured to convert the helical flow induced by the helical separator 116 into an axial flow along the A-axis. A catalyst substrate 120 or catalytic converter 120 having a plurality of tubes 122 for the axial fluid flow there-through is deposed downstream of the deflector 118. Selected portions of the housing 102, helical separator 116, deflector 118, and/or catalytic substrate 120 are coated with a catalyst for converting various undesirable constituents, or chemical compounds, to more desirable or inert constituents, or chemical compounds.

The housing 102 includes an interior surface 124 defining a cylindrical chamber 126 having an interior cylindrical side wall 128 extending along the A-axis. The interior cylindrical side wall extends 128 from the first end 104 toward the conical portion 112. The catalytic converter 120 is disposed in the cylindrical chamber 126 proximal to the conical portion 112. The catalytic converter 120 defines a plurality of tubes 122 including a central opening 130. The helical separator 116 includes an elongated member 132 having an external cylindrical surface 134. The elongated member 132 includes a first distal end 136 and a second distal end 138 opposite that of the first distal end 136. The first distal end 136 of the elongated member 132 is fixed to the interior surface 124 proximal to the first end 104 of the housing 102 and the second distal end 138 is extended through the central opening 130 of the catalytic converter 120. The catalytic converter 120 may be configured to support the second distal end 138 of elongated member 132 through the central opening 130.

A vane 140 extends from the external cylindrical surface 134 of the elongated member 132 in a helical path from the first distal end 136 toward the second distal end 138. The vane 140 includes a first surface 142, a second surface 144 opposite of the first surface 142, and a distal edge surface 146 connecting the first surface 142 with the second surface 144. The distal edge surface 146 of the vane 140 is in intimate contact with the interior surface 124 of the housing 102. The first and second surfaces 142, 144 of the vane 140 cooperates with the interior surface 124 of the housing 102 to define a helical passageway 148 for guiding a fluid flow from the inlet tube 108 toward deflector 118. It is preferable that the edge surface 146 includes a shape that is complementary to the shape of the interior surface 124 of the housing 102 at the point of contact in order to provide a snug fit to prevent fluid leakage from the first surface 142 to the second surface 144 via the edge surface 146.

The distance between adjacent corresponding segments of the edge surface 146 when measured parallel to the A-axis, as shown in FIG. 2, is represented by the length (L). The length (L) is also referred to as the length (L) between adjacent edge surfaces 146. A helix angle (a) is the angle between the edge surface 146 of the vane 140 and the longitudinal A-axis as shown in FIG. 2 when viewed in cross-section. Depending on the application for the vortex flow apparatus 100, the length (L) between adjacent edge surfaces 146 and the helix angle (a) may be constant or varied throughout the length of the helical separator 116.

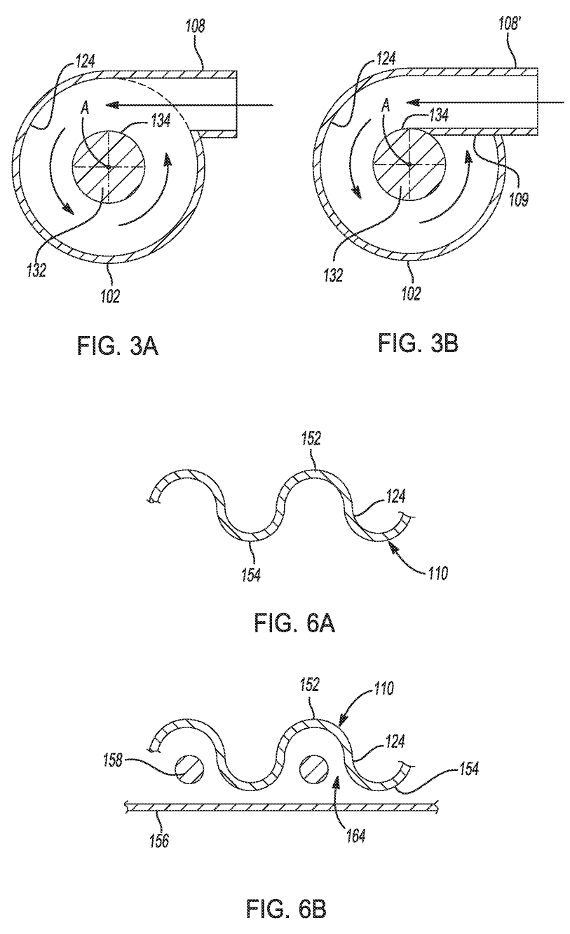

FIGS. 3A and 3B shows a cross-section view of the vortex flow apparatus 100 along section 3-3 of FIG. 2. FIG. 3A shows an embodiment where the inlet tube 108 extends tangential from the elongated housing 102. Fluid flow enters the vortex flow apparatus 100 through the inlet tube 108 at a right (90 degrees) angle with respect to the A-axis or any angle up to the helix angle (a) immediately adjacent the Inlet tube 108. The incoming fluid flow deflects against the interior surface 124 of the housing 102 and the momentum of the fluid carries the fluid through the helical passageway 148 toward the deflector 118 in a circular vortex flow within the cylindrical chamber 126 of the vortex flow apparatus 100 as shown in FIG. 2. FIG. 3B shows an embodiment where the inlet tube 108′ extends through the elongated housing 102 and into the cylindrical chamber 126. The inlet tube 108′ includes an interior tube segment 109 extending up the cylindrical surface 134 of the elongated member 132, thereby providing a more direct path for the fluid flow to the interior surface 124 of the housing 102 located opposite of the inlet tube 108′.

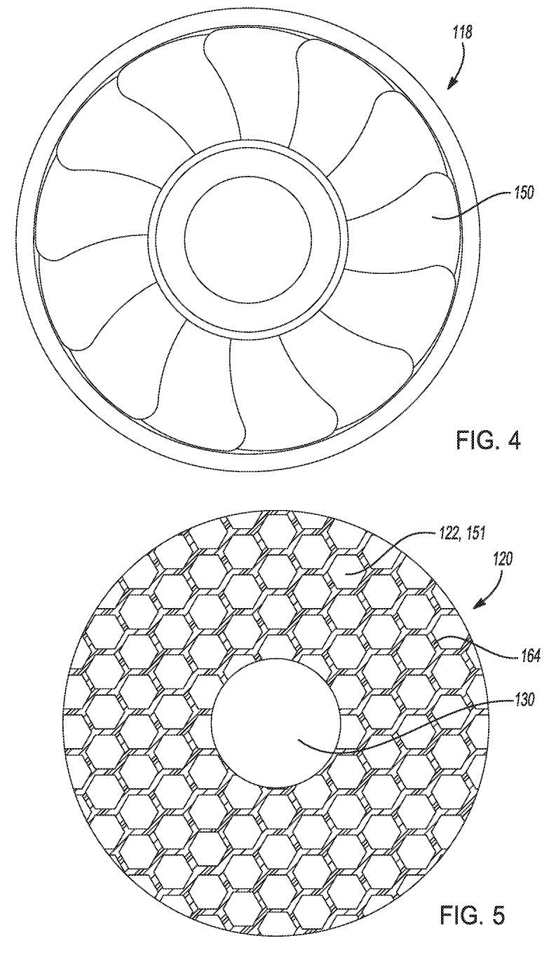

FIG. 4 shows the deflector 118 across section 4-4 of FIG. 2. The embodiment shown includes a plurality of deflector vanes 150 positioned at a sufficient angle to redirect the vortex flow exiting the helical passageway 148 into an axial flow toward the catalytic converter 120.

FIG. 5 shows the catalytic converter 120 across section 5-5 of FIG. 2. In the embodiment shown, the catalytic converter 120 includes a plurality of tubes 122 parallel to the A-axis. The tubes 122 defines channels 151 for guiding the axially fluid flow exiting from the deflector 118 to the outlet tube 114. The central opening 130 defined by the catalytic converter 120 includes a shape complementary to the cross-sectional shape of the second distal end 138 of the elongated member 132. The central opening 130 receives and retains the second distal end 138 of the elongated member 132.

FIG. 6 shows a fragmented cross-section of the housing 102 across line 6-6 of FIG. 2. FIG. 6A shows the interior surface 124 having a plurality of ribs 152 that extends helically around the cylindrical chamber 126. The plurality of ribs 152 increases the area of the interior surface 124 of the cylindrical chamber 126 as well as strengthens the housing 102, thereby allowing reduced thickness of the housing 102. The side wall 110 of the housing 102 includes the interior surface 124 and an exterior surface 154. Referring back to FIG. 2, the plurality of ribs 152 are oriented in a first direction 152A in such a way to facilitate the vortex flow of fluid or oriented in a second direction 152B to obstruct the vortex flow of fluid to enhance turbulent flow through the cylindrical chamber 126. FIG. 6B shows an alternative embodiment of the housing 102 in which an external shell 156, or outer wall 156, is wrapped about the exterior surface 154 of the side wall 110. Thermal insulating material or an electrical coil defining a heat jacket 158 may be disposed between the side wall 110 and the outer wall 156.

The vortex flow apparatus 100 may be configured to function as a catalytic converter to reduce or eliminate various undesirable constituents, or chemical compounds, in the exhaust gases of an internal combustion engine of a motor vehicle. The vortex flow apparatus 100 may be positioned in the exhaust system (not shown) of the motor vehicle as a separate unit between the engine exhaust manifold and the muffler. In this example, the vortex flow apparatus 100 may be configured to be used as a two-way or three-way catalytic converter of exhaust gases emanating from the internal combustion engine. In a two-way configuration, the vortex flow apparatus 100 oxidizes carbon monoxide to carbon dioxide and unburnt hydrocarbons to carbon dioxide and water. In a three-way configuration, the vortex flow apparatus 100 also converts nitrogen oxides to nitrogen and oxygen by reduction, as well oxidizes carbon monoxide to carbon dioxide and unburnt hydrocarbons to carbon dioxide and water.

Precious metals such as platinum, palladium, rhodium, and to a lesser extent, cerium, iron, and manganese may be used as part of a catalyst coating in the vortex flow apparatus 100. Typically, platinum is used both as a reduction and oxidation catalyst, palladium is used as an oxidation catalyst, and rhodium is used as a reduction catalyst. An oxidation phase coating 160 may be applied to a first portion of the interior surface of the housing 102 defining the cylindrical chamber 126 and a reduction phase coating 162 may be applied to a second portion of the interior surface of the housing 102 defining the cylindrical chamber 126. The reduction phase coating 162 is spaced from the oxidation phase coating 160 and may be upstream or downstream of the oxidation phase coating 160 with respect to the direction of the exhaust gas flow through the vortex flow apparatus 100. It should be appreciated that other materials that behave as catalysts may be substituted for the platinum group metals. It should also be appreciated that a combination oxidation and reduction phase coating may be utilized.

Referring to FIG. 6, corrugation or other grooving of any or all coated surfaces may be used for the purpose of increasing the area of the coated surface. The corrugated surface defining the plurality of ribs 152 increases the surface area available for applying the oxidation and/or reduction phase coatings 160, 162. To further increase the surface area available for coating, a reduction phase coating 162 may be applied to one of the first and second surfaces 142, 144 of the helical vane 140 and an oxidation phase coating may be applied to the other of the first and second surfaces 142, 144 of the helical vane 140. The external cylindrical surface 134 and the vane surfaces 142, 144 of the helical separator 116 may include a plurality of ribs to still further increase the surface area available for the application of the oxidation and/or reduction phase coatings 160, 162.

Portions of the vortex flow apparatus 100 may be formed of steel or stainless-steel or other material sufficiently refractory for the purpose. The catalyst coating may be applied directly to the interior surface 124 of the cylindrical chamber 126, or to a prime coat of alumina or other ceramic applied to the surfaces of the apparatus to act as a substrate for the catalyst. The interior surfaces of the vortex flow apparatus 100 may be roughened by sandblasting, etching or other means preparatory to the application of a prime coating and/or directly-applied catalyst so as to multiple the true surface area presented to the exhaust gases. Selected surfaces of the vortex flow apparatus 100, including the interior surfaces 124 of the cylindrical chamber 126, helical separator 116, and deflector 118, are coated by a ceramic wash carrying a mixture of metals that may include but is not limited to platinum, rhodium and palladium.

The catalytic converter 120 shown in FIG. 5, which is located downstream of the catalytic coatings, may be that of a supplementary clean-up catalytic converter 120 such as a catalyst configured to clean up any residual carbon-monoxide, unburnt hydrocarbons, and nitrogen oxides. The supplementary clean-up catalytic converter 120 may be that of an extruded ceramic honeycomb structure 164 of a refractory material such as cordierite (2MgO-5SiO₂-2Al₂ O₃) or mullite, (3Al₂ O₃-2SiO₂). The honeycomb structure may be wash coated with a thin layer of a catalyst carrier such as alumina or zirconium oxide to increase the effective surface area. The increased surface area is uniformly impregnated throughout with a noble metal mixture such as platinum, palladium, and rhodium.

The exhaust gas is introduced to the vortex flow apparatus 100 at the inlet tube 108 to form a vortex that encounters surfaces coated with catalytic material to chemically convert the undesired chemical compounds in the exhaust gases to more desired chemical compounds before exiting the outlet tube 114. Turbulence of the exhaust gases generated from the vortex action created within the vortex flow apparatus 100 enhances efficiency of the catalytic action, thereby enabling the reduction of surface area that is required to be coated with a catalytic coating. The reduced surface area reduces the quantity of precious metal required by the catalytic converter. The length (L) of the catalytic chamber and the helix angle (a) of the vane 140 may be adjusted as necessary to provide sufficient area of for the catalyst to convert all gases.

Referring to back to FIG. 6B, the exterior surface 154 of the side wall 110 of the cylindrical chamber 126 may be enclosed within an outer wall 156 to guard against road damage from road hazards such as stones and objects. Provision of the outer wall 156 acts as a shield to protect the cylindrical chamber 126 from bruising that might dislodge or fracture the catalytic coating. An outer chamber 164 is defined between the side wall 110 and outer wall 156. The outer chamber 164 be wrapped with an insulating material or heating elements such heat tape to form a heat jacket 158 to enhance the catalytic reaction during cold starts.

When the internal combustion engine is initially started, the electrical heat jacket 158 is activated and generates heat to rapidly raise the temperature of the catalyst to its effective temperature. Catalytic conversion begins and the exothermic conversion reactions provide additional heat that raises other portions of the coated surfaces to operating temperature. Usually by this time, the exhaust gases reaching the converter also are at a temperature conducive to effective conversion.

The vortex flow apparatus 100 may be formed from sheet metal, such as stainless steel, manufactured by processes in common use, and assembled by welding, again using processes in common use. The honeycomb clean-up catalytic converter 120 would be similar in construction and manufacture to converters currently in use. The vortex flow apparatus 100 offers less resistance to the flow of exhaust gases than do conventional ceramic-core converters now in use, thereby reducing backpressure to enhance scavenging of the engine combustion chamber. Fuel economy benefits as a result. Furthermore, the vortex flow apparatus 100 requires less catalyst (i.e. less precious metals) than convention catalytic converters due to the turbulent helical flow of the exhaust gases through cylindrical chamber 126.

Testing was conducted using a bench model of the fluid conversion apparatus. The exhaust gases from an internal combustion engine running on Amoco Clear fuel was routed through the bench model. The inlet temperature of the exhaust gas was measured and the corresponding HC, CO, and NOx was quantified in the inlet exhaust gas. The conversion of the HC, CO, and NOx to CO₂, N₂, and H₂O was measured at the outlet of the bench model.

For comparison, the exhaust gas from the internal combustion engine was routed through a standard three-way catalytic converter having a honeycomb substrate. Calculations were conducted to estimate the equivalent amount of precious metals required by the bench model to convert the equivalent amount of HC, CO, and NOx to CO₂, N₂, and H₂O, as that of the standard three-way catalytic converter. The calculations was conducted assuming the thickness of coating of the precious metal onto the surfaces of the bench model and honey comb structure to be equal.

It was found that apparatus requires less than 15 to 20 percent of the surface area required for a typical honeycomb structure catalytic converter. In other words, it is projected that the vortex flow apparatus 100 will require less than one-fifth of the amount of precious metals as that of a convention catalytic converter.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. A vortex flow catalytic conversion apparatus, comprising:
an elongated housing having a first end, a second end opposite of the first end, and an interior surface defining a chamber having an interior side wall;
an inlet tube extending from the housing proximal to the first end, wherein the inlet tube defines an inlet opening into the chamber;
an outlet tube extending from the housing proximal to the second end, wherein the outlet tube defines an outlet opening;
a helical separator disposed within the chamber, wherein the helical separator cooperates with the interior side wall to define a helical passageway for inducing a vortex flow of fluid; and
a catalyst coating applied on a portion of at least one of the interior side wall and the helical separator.

2. The vortex flow catalytic conversion apparatus of claim 1, further comprising:
a catalytic converter disposed in the chamber downstream of the helical separator, wherein the catalytic converter includes a plurality of axial fluid flow passageways.

3. The vortex flow catalytic conversion apparatus of claim 2, further comprising:
a deflector disposed in the chamber downstream of the helical separator and upstream of the catalytic converter, wherein the deflector includes vanes configured to redirect the vortex flow of fluid exiting the helical passageway to an axial flow of fluid.

4. The vortex flow catalytic conversion apparatus of claim 3, wherein the catalytic converter is a clean-up catalytic converter.

5. The vortex flow catalytic conversion apparatus of claim 1, wherein the catalyst coating includes: (i) one of an oxidation phase coating or a reduction phase coating applied on an upstream portion of the interior side wall, and the other of the oxidation phase coating or reduction phase coating applied on a downstream portion of the interior side wall; or (ii) a combination oxidation and reduction phase coating applied to a portion of the interior side wall or to a portion of the helical separator.

6. The vortex flow catalytic conversion apparatus of claim 1,
wherein the helical separator includes an elongated member having a vane extending helically from a first distal end toward a second distal end of the elongated member;
wherein the vane includes a first surface and a second surface opposite the first surface; and
wherein one of the first and second surfaces is coated with one of a reduction coating or an oxidation coating, and the other of the first and second surfaces is coated with the other of the reduction coating or the oxidation coating.

7. The vortex flow catalytic conversion apparatus of claim 6, wherein the vane includes an edge surface connecting the first surface and the second surface, wherein the lengths between adjacent helical vane edge surfaces and helix angle (α) are varied.

8. The vortex flow catalytic conversion apparatus of claim 7, wherein the helical separator includes a plurality of ribs protruding from at least one of the elongated member, the first surface of the vane, and the second surface of the vane.

9. The vortex flow catalytic conversion apparatus of claim 1, further comprising a first set of ribs protruding into the helical passageway in a first helical direction from the interior side wall and a second set of ribs protruding into the helical passageway in a second helical direction from the interior side wall.

10. The vortex flow catalytic conversion apparatus of claim 1, wherein the inlet tube extends from the housing at an angle having a range from 90 degrees to a helix angle α adjacent the inlet tube.

11. The vortex flow catalytic conversion apparatus of claim 1, further comprising an exterior wall shielding at least a portion of the elongated housing.

12. The vortex flow catalytic conversion apparatus of claim 11, further comprising a heating jacket disposed between the elongated housing and the exterior wall.

13. A vortex flow apparatus comprising:
an elongated housing extending along an axis, wherein the elongated housing includes a first end, a second end opposite the first end, and an interior surface defining a cylindrical chamber having an interior side wall;
an inlet tube extending tangentially from the elongated housing proximal to the first end;
an outlet tube extending from the elongated housing proximal to the second end;
a helical separator disposed within the cylindrical chamber, wherein the helical separator cooperates with the interior side wall to define a helical fluid flow passageway extending from the first end toward the second end; and
a deflector disposed within the cylindrical chamber downstream of the helical separator, wherein the deflector is configured to redirect a helical flow exiting the helical fluid flow passageway into an axial fluid flow toward the outlet tube.

14. The vortex flow apparatus of claim 13, further comprising:
a catalyst substrate disposed downstream of the deflector, wherein the catalyst substrate includes a plurality of tubes defining a plurality of axially flow passageways for receiving the axial fluid flow from the deflector.

15. The vortex flow apparatus of claim 14,
wherein the catalyst substrate defines a central opening;
wherein the helical separator includes an elongated member having a first distal end and a second distal end opposite the first distal end; and
wherein the first distal end is fixed to a portion of the interior surface proximal to the first end of the housing and the second distal end is received within the central opening of the catalytic converter.

16. The vortex flow apparatus of claim 15,
wherein the helical separator includes a vane extending from an external surface in a helical path from the first end to the second distal end;
wherein the vane includes a first surface, a second surface opposite the first surface, and an edge surface connecting the first surface with the second surface; and
wherein the edge surface includes a profile that is complementary a contour of the interior surface of the cylindrical chamber such that the edge surface conformingly abuts the interior surface.

17. The vortex flow apparatus of claim 16, further comprising a catalyst coating applied to at least one surface selected from a group consisting of the interior surface of the housing, the first surface of the vane, the second surface of the vane, a surface on the elongated member, and catalyst substrate.

18. A vortex flow apparatus comprising of claim 13, wherein the elongated housing further includes a tapered portion that narrows along the axis toward the second end defining the outlet tube.

19. A method of vortex flow catalytic conversion of a fluid, comprising the steps of:
creating a vortex flow of the fluid by passing the fluid through a helical passageway about a longitudinal axis; and
exposing the vortex flow of the fluid to at least one catalyst coating in the helical passageway.

20. The method of claim 19, further including the steps of:
redirecting the vortex flow of the fluid exiting the helical passageway to an axial flow of the fluid along the longitudinal axis; and
passing the axial flow of the fluid through a clean-up catalytic converter.

21. The method of claim 20, further including the step of exposing the vortex flow of the fluid to a plurality of ribs protruding into the helical passageway, thereby enhancing turbulence in the vortex flow of the fluid.

22. The method of claim 21, further including the step of heating the vortex flow of the fluid in the helical passageway to a temperature conducive to effective conversion of the fluid flow by the catalyst coating.
